(19) United States
(12) Patent Application Publication
(10) Pub. No.: US 2004/0240946 A1
(43) Pub. Date: Dec. 2, 2004

(54) Floating platform with separators and storage tanks for LNG and liquid gas forms of hydrocarbons

(75) Inventor: Richard D. Haun, Katy, TX (US)

Correspondence Address: PAUL S MADAN, MADAN, MOSSMAN & SRIRAM, PC, 2603 AUGUSTA, SUITE 700, HOUSTON, TX, 77057-1130, US

(73) Assignee: OPE Technology, LLC, Houston, TX

(21) Appl. No.: 10/888,647

(22) Filed: Jul. 9, 2004

Related U.S. Application Data
(63) Continuation-in-part of application No. 09/980,844, filed on Oct. 22, 2001, now Pat. No. 6,761,508.

(51) Int. Cl. E02D 23/02; F17C 5/00

(52) U.S. Cl. 405/224; 405/205; 114/264

(57) ABSTRACT

A floating platform of vertical axial symmetry which provides processing and/or storage of liquefied hydrocarbon gas. The platform is fixed by mooring or made mobile by added vessel or self-mobilization.

The processing and storage being contained in the floating vessel hull, on the deck, or within a center assembly of the floating vessel. The addition of tanks for storage of LNG and liquefied gases conforming to a non-shipshape hull having nonparallel sides, which maximize the volumetric capacity of the structure, yet minimize the stored fluid product mass dynamic effects on the floating vessel.

This application is a continuation-in-part (CIP) of U.S. patent application Ser. No. 09/980,844 filed Oct. 22, 2001.

### BACKGROUND OF THE INVENTION

1. Field of the Invention

The invention relates to vertically axial symmetric offshore platforms and buoys with hull-based separator and storage vessels and tanks with features for containment of LNG and liquid forms of gases (liquefied gases).

2. Description of the Related Art

The country's gas supply requirements have increased due to reductions of available gas supplies within the U.S. to meet the energy needs of the country. These requirements have placed new importance on LNG imports to the country. LNG, or Liquefied Natural Gas, is the liquefied state of methane gas maintained at a temperature of minus 260 degrees Fahrenheit at atmospheric pressures.

LNG supply has high perceived risks due in part to the potential hazards associated with storage before regasification. A distant offshore supply and storage method will remove potential and perceived risks from onshore facilities and the public while simultaneously satisfying the growing demand for clean energy.

Utilizing economic axisymmetric floating platforms will increase the safety for receipt and storage of LNG and/or liquid gases. As a result, the storage before regasification into normal gas is done safely offshore, thereby eliminating any risks to the public and onshore facilities. This approach is common for storage and shuttling of oil all around the world via storage and offloading vessels termed FSO's (Floating Storage and Offloading) or FPSO's (Floating Processing Facilities, Storage and Offloading). However, the implementation of a non-shipshaped or non concrete fixed floating steel platform for storage of LNG/liquefied gas has not been addressed in the prior art. The current storage is performed in conventional ship shapes, which present high risks due to instability in sudden storms. Also proposed are grounded concrete barges, which have limited application due to their practical use only in shallow water. A related need is for an offshore floating platform or facility that permits storage of LNG and other forms of liquefied hydrocarbon gas and which can provide improved motions and safety during offloading independent of water depth, thereby allowing significant offshore placement options. Related issues and embodiments of the present invention are the tank features, which are utilized as follows: to optimize space; to absorb kinematic fluid energy due to the motion of the floating facility; to provide a practical means of connection to the floating facility; to provide a means of thermal/pressure environmental control; and to provide a means of attachment of insulation and a selection of preferred economic materials.

### SUMMARY OF THE INVENTION

The present invention provides for an offshore floating facility for storage of LNG and other forms of liquefied hydrocarbon gas such as LPG, or Liquid propane, Butane and other non-hydrocarbon gases in liquid forms under controlled pressure and temperature. By reference to the cited U.S. patent Ser. No. 09/980,844, separation and storage vessels have been proposed within the center column of the structures. It is further proposed that these separation and storage vessels be stored within the hull and on the deck of these and similar offshore moored steel vessels. It is further proposed that the tanks may contain features of form for maximizing available space and features that absorb the contained fluid motion caused by motion of the offshore floating facility in seas. Fluid motion generates heat and boil off of liquid gases. Central to the invention is minimizing the fluid motion to prevent vaporization. This is accommodated by improving the motions of the floating vessel, minimizing the degree of product placed into motion by the floating vessel motion and the strategic use of baffles.

### BRIEF DESCRIPTION OF THE DRAWINGS

For further understanding of the nature and objects of the present invention, reference should be had to the following drawings in which like parts are given like reference numerals and wherein:

FIG. 1 presents an elevation view of a floating vessel 100 in accordance with the present invention.

FIG. 2 presents an elevation view (partially cut-away) of the vessel shown in FIG. 1.

FIG. 2a presents a storage tank with radial sides and an internal energy dissipating baffle.

FIG. 2b presents a plan section view of the floating vessel hull filled with storage tanks in a radial configuration.

FIG. 3 is a detail view depicting an exemplary temperature control system for a storage vessel in accordance with the present invention.

FIG. 4 is a block diagram illustrating steps in an exemplary storage method in accordance with the present invention.

### DETAILED DESCRIPTION OF THE PREFERRED EMBODIMENTS

U.S. patent application Ser. No. 09/980,844, entitled “Satellite Separator Platform” describes as a floating vessel having a floating hull structure with a center column assembly that is non-telescoping extendable and retractable with respect to the hull structure. U.S. patent application Ser. No. 09/980,844, which is owned by the assignee of the present invention, is hereby incorporated herein by reference. That application describes the use of fluid separators within the center column assembly of the platform. In accordance with the present invention, there are provided means within the floating hull and/or atop the hull for storage of LNG/liquefied gas. Additionally, such storage may be provided within the center column assembly.

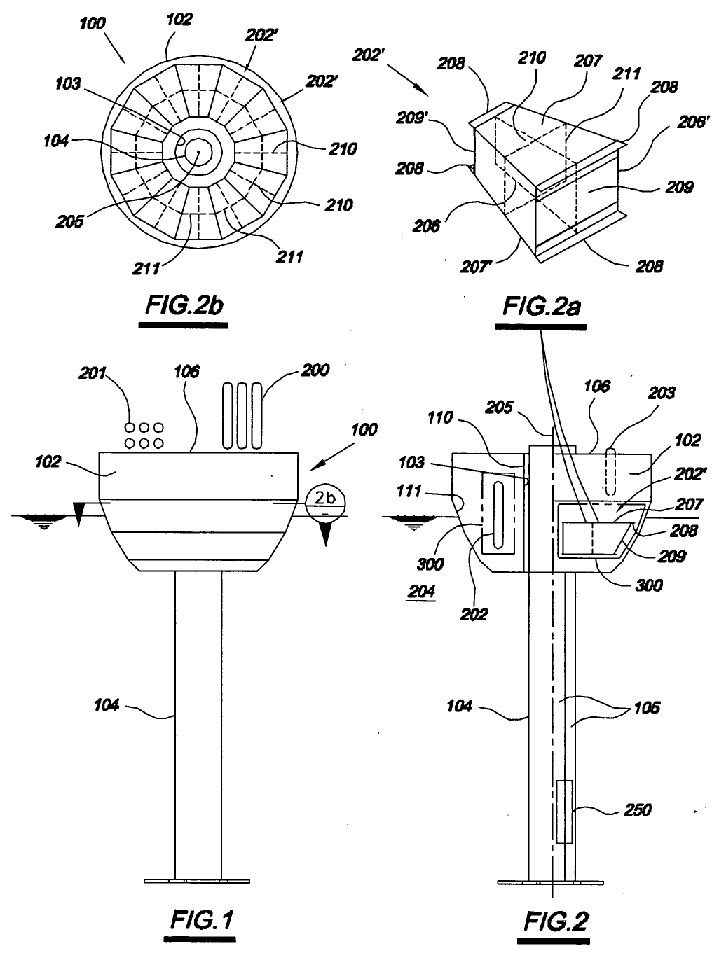

FIG. 1 depicts a floating vessel 100 having a floating hull structure 102 and a center column assembly 104. The center column assembly 104 is retained within a hollow central section 103 (in FIG. 2) and is axially moveable with respect to the hull 102 SO that the center column assembly 104 is extendable and retractable vertically below the hull 102. The center column assembly 104 preferably includes a plurality of longitudinal fluid separators 105 for separation of fluid components from a fluid mixture. The hull 102 presents an upper deck 106 for the support of a crane (not shown), a helipad (not shown) and other equipment useful for operation on the platform 100. Items 200 and 201 are deck-mounted vessels shown in either horizontal or vertical position and supported upon the upper deck 106.

The elevation view provided by FIG. 2 reveals storage vessels 202 within the hull 102 for containing LNG or liquefied gas. The storage vessels 202 provide storage and/or separation, or processing of the hydrocarbons. The storage vessels 202 may extend above the deck 106 as shown at 203.

The storage vessels 202 containing the LNG or liquefied gas are formed to accommodate a hull 102 which has vertical axial symmetry, thus, curved inner 110 and outer 111 walls. The radial hull 102 shape provides axial symmetry on the vertical axis and thus provides natural structural advantages due to the effective stiffness provided by the general curved geometry, as in the increased strength of a structural arch over a straight beam. The radial sides and baffling of the storage vessels 202 benefit from similar stiffness. Added stiffeners for the storage vessels 202 and 202′ would be both internal to resist rotational motion of the fluid and external to provide natural support points for the internal stiffeners of the hull 102. The storage vessels 202 and 202′ may further be provided with an environmental boundary 300, as shown in FIG. 2, to maintain the volumetric or separation efficiency. The storage tank 202′ as shown in FIG. 2A presents certain embodiments of the present invention treating the storage tank features. The sides 206 and 206′ are separated by an angle to maximize the radial space of the vessel of axial symmetry. The top 207 and bottom 207′ are shown to further deviate from a parallel arrangement. The outer surface 209 and inner surface 209′ of the tank are parallel for the case shown but would be configured to maximize the tank volume within the available space of the floating vessel hull. Baffle 210, within the tank, allows only a small percentage of the fluid cross-sectioned area to pass unrestricted in order to accomplish the degree of energy damping necessary to prevent free surface effects of the fluid and their effects on the floating facility. Stiffeners 208 have many purposes: (a) preventing low frequency response of the storage tank; (b) providing a means of attachment to the floating hull internal stiffeners and (c) providing a means of attachment of external insulation. Other external and internal stiffeners (not shown) may also be incorporated to facilitate fabrication and handling for placing the storage tanks in the floating hull.

The environmental boundary 300 is provided by a shell or jacket of protective insulation. Within the environmental boundary 300, the temperature of the content of the vessel 200, 201, 202, 250, 202′ is controlled within a desired range. Insulation and normal measures for temperature controls are provided. The environmental boundary may be comprised of external insulation on a storage vessel 202′ or it may enclose multiple storage vessels 200, 201, 202, 250, 202′ as a group. This group arrangement for storage vessel 200, 201, 202, 250, 202′ could, therefore, yield a tank similar to a torus in the plan view FIG. 2b and circumferential baffles 211 are used to provide structural stiffness and reduce the fluid motion from affecting the motion of the floating vessel 100.

With the full tank radial arrangement, as shown in FIG. 2b, the fluid elements, which travel most efficiently in a straight direction, are provided a restricted path of ever changing direction through the baffling 210 and 211, which absorb a great amount of kinetic energy in the fluid contained in the tanks. The efficiency in the system lies in the feature that, as the floating vessel 100 responds to wave motion, the fluid compression pulse transferred, to begin fluid motion by the inner walls 209, 209′, 207, 207′ of each tank segment, produces different vector directions of pressure perpendicular to their walls 209, 209′, 207, 207′. Since the total mass of the contained fluid in all the tanks is acted on by different pressure pulses in different directions, only a small portion of the fluid is put in motion. The over damping of the baffles 210 and 211 further tends to restrain the fluid from gaining mass velocity. This reduces the amount of fluid mass in motion and decreases the velocity of the reduced fluid mass, thereby greatly reducing the kinetic energy of the fluid that is imparted back onto the opposite vessel walls 209′, 209, 207′, 207. As a result, the force transferred to floating vessel 100 by contained fluid minimally affects its motion.

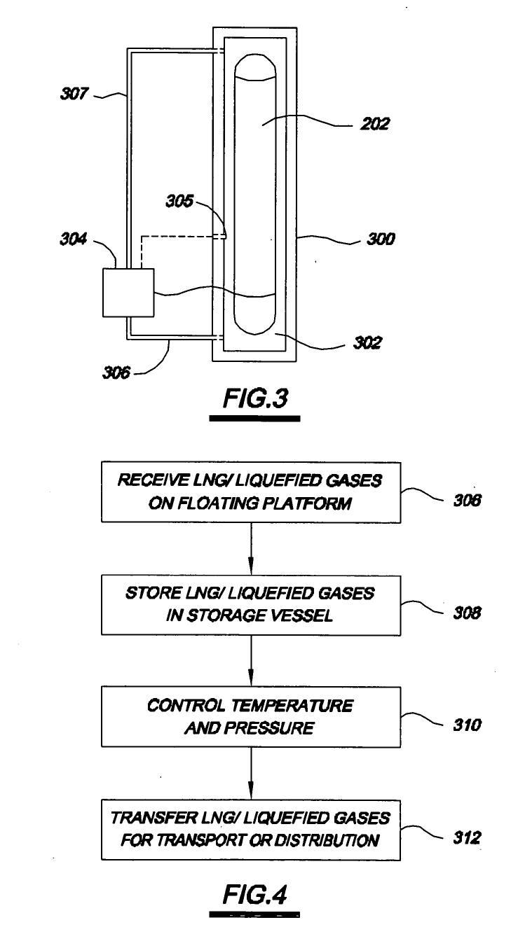

The outer surface of the vessels 200, 201, 202, 202′ are designed to include insulation methodology to reduce the transfer of heat to or from the surrounding seawater 204 and hull deck 106 to the contained LNG or liquefied gas. FIG. 3 illustrates, in schematic fashion, an exemplary temperature control system for the storage vessel 202 within the environmental boundary 300. A cooled space 302 surrounds the storage vessel 202 and an operably associated controller 304, of a type known in the art, controls the cooled space 302 to maintain the storage vessel 202 and its contents at or near a predetermined temperature. Although FIG. 3 only shows the temperature control arrangement with respect to vessel 202, it should be understood that it may be used for all such storage vessels of the platform 100. Temperature control is important in the instance of LNG and other liquefied gases to ensure that they do not vaporize from their liquid state.

Embodiments of the present invention provide for an offshore floating structure with separators and/or storage vessels and tanks for containment and control of refrigerated liquid forms of gases in either the center column assembly 104, within the hull 102, or upon the deck 106 of the hull 102.

The systems and methods of the present invention provide for temporary or interim storage of LNG/liquefied gas. In operation, the floating platform, such as platform 100, is positioned proximate to LNG and/or the liquefied gas production facilities (not shown). It is then moored into place. FIG. 4 illustrates steps for a method of storing LNG/liquefied gas in or upon the platform 100. Stored LNG and/or liquid gases are transmitted to the platform 100 via hoses or other conduits (not shown) of a type known in the art (step 306). The liquid gases are then stored within storage vessels 200, 201, 202, 202′ or 250 (step 308). Temperature and pressure are controlled for the storage vessels during storage of the liquid gases (step 310). Finally, the liquid gases are transferred to either other storage or re-gasification facilities. (step 312).

Additionally, temporary/interim storage of LNG/liquefied gas may be accomplished within the context of the present invention within floating platforms having designs other than that of the floating vessel 100 described above. The solution of effective LNG/liquefied gas storage in a moored vessel for purposes of enabling LNG/liquefied gas transfer offshore is known within the industry, however it is greatly enhanced by use of the tank designs presented herein to minimize vaporization due to damping and wave action of excess fluid motion.

In addition, the platform 100 may provide for storage of LNG/liquefied gases within the center column assembly 104. FIG. 2 illustrates storage vessel 250 within the center column assembly 104.

The best mode and preferred embodiments of the invention have been described. It is to be understood that the invention is not limited, thereto, but rather is to be measured by the scope and spirit of appended claims.

What is claimed is:

1. A floating structure comprising:
a floatable hull that presents an upper deck;
a center column assembly that is vertically movably disposed within the hull; and
a pressure and temperature controlled storage vessel for liquefied gases.

2. The floating structure of claim 1 wherein the storage vessel is provided within the main hull.

3. The floating structure of claim 1 wherein the storage vessel is provided atop the main hull.

4. The floating structure of claim 1 wherein the storage vessel is provided within a center column assembly of the floating structure.

5. The floating structure of claim 1 wherein the storage vessel is surrounded by an environmental boundary.

6. The floating structure of claim 5 wherein the environmental boundary of the storage vessel comprises an insulated shell.

7. The floating structure of claim 5 wherein temperature is controlled within the environmental boundary.

8. The floating structure of claim 5 wherein the hull is vertically axially symmetic.

9. The floating structure of claim 1 wherein the storage vessels are comprised substantially of aluminum.

10. The floating vessel of claim 1 wherein the storage vessels are comprised substantially of nickel-alloyed steel.

11. A floating structure comprising:
a floatable hull that presents an upper deck and defines a hollow central section there within;
a center assembly mounted within the hollow central section and being retractable and extendable below the hull; and
a plurality of storage vessels disposed within the floating structure, for storage of LNG or liquefied gases.

12. The floating structure of claim 11 wherein a floating structure is fixed, moored or mobile.

13. The floating structure of the claim 11 wherein at least one of the storage vessels is located upon the upper deck.

14. The floating structure of the claim 11 wherein at least one of the storage vessels is located within the floating hull.

15. The floating structure of the claim 11 wherein at least one of the storage vessels is located within the center column assembly.

16. A floating structure of vertical axial symmetry for having a plurality of storage vessels therein for temporary storage of materials of the group consisting of 1) LNG and 2) liquid gas forms.

17. A method of storing LNG and liquid gas forms following production and prior to transport to a remote location, comprising the steps of:
disposing said gases within a storage vessel upon a floating platform of vertical axial symmetry;
controlling the temperature of the storage vessel.

18. The method of claim 17 further comprising the step of offloading the contents to a transport tanker.

19. The method of claim 17 further comprising the step of mooring the floating platform in place proximate an offshore berth or transport vessel for transferring the liquefied hydrocarbon gases in and out of the storage vessels.

20. A storage tank within the hull of a floating vessel departing from a conventional ship-shape comprising liquefied storage vessel tank sides; which include external stiffeners that serve as structural supports and attachment points for insulation; which include at least two nonparallel, radially emanating tank walls.

21. The storage tank of claim 19 having nonparallel top and bottom tank walls.

22. The storage tank of claim 19 further comprising internal baffle plates which encounter the fluid movement and cause absorption of kinetic fluid energy.

23. The storage tank of claim 22 wherein the baffles allow passage of at least 1 percent of the cross-sectional tank area.
